(19) United States
(12) Patent Application Publication
(10) Pub. No.: US 2021/0092526 A1
(43) Pub. Date: Mar. 25, 2021

(54) SPEAKER CONES FOR SELF-COOLING HEADSETS

(71) Applicant: HEWLETT-PACKARD DEVELOPMENT COMPANY, L.P., Spring, TX (US)

(72) Inventors: Jon R. Dory, Spring, TX (US); David H. Hanes, Fort Collins, CO (US); James Glenn Dowdy, Fort Collins, CO (US)

(73) Assignee: HEWLETT-PACKARD DEVELOPMENT COMPANY, L.P., Spring, TX (US)

(21) Appl. No.: 16/603,459

(22) PCT Filed: Apr. 21, 2017
(86) PCT No.: PCT/US2017/028992

§ 371 Date: Oct. 7, 2019

(51) Int. Cl. H04R 9/02; H04R 1/24; H04R 1/10

(52) U.S. Cl. CPC H04R 9/022; H04R 1/24; H04R 1/1041; H04R 1/1033; H04R 9/06; H04R 1/1091; H04R 1/1075; H04R 2420/07; H04R 2460/11; H04R 1/1008

(57) ABSTRACT

In an example implementation, a self-cooling headset includes an ear cup to form an ear enclosure when placed over a user's ear, a first valve to open and release air from the ear enclosure, and a second valve to open and admit air into the ear enclosure. The headset also includes a first speaker cone to translate an audio frequency signal into audible sound, and a second speaker cone to translate a subsonic frequency signal into air movement that produces positive and negative air pressures within the ear enclosure to open and close the first and second valves.

### BACKGROUND

Audio headsets, headphones, and earphones generally comprise speakers that rest over a user's ears to help isolate sound from noise in the surrounding environment. While the term “headset” is sometimes used in a general way to refer to all three of these types of head-worn audio devices, it is most often considered to denote an ear-worn speaker or speakers combined with a microphone that allows users to interact with one another over telecom systems, intercom systems, computer systems, gaming systems, and so on. As used herein, the term “headset” is intended to refer to head-worn audio devices with and without a microphone. The term “headphones” can refer more specifically to a pair of ear-worn speakers with no microphone that allow a single user to listen to an audio source privately. Headsets and headphones often comprise ear cups that fully enclose each ear within an isolated audio environment, while earphones can fit against the outside of the ear or directly into the ear canal.

### BRIEF DESCRIPTION OF THE DRAWINGS

Examples will now be described with reference to the accompanying drawings, in which:

FIG. 1 shows an example of a self-cooling headset in which a coaxial speaker includes a first speaker cone to produce audible sound, and a second speaker cone to produce positive and negative air pressures that open and close check valves of an ear cup;

FIG. 2 shows an example of a self-cooling headset with additional details to illustrate an example construction and operation of the headset;

FIG. 3 shows an example of how an example umbrella check valve may be implemented within an entry and exit port of an ear cup;

FIG. 4 shows an example of a self-cooling headset that illustrates alternate example operating modes and additional details of an example construction and operation of the headset;

FIGS. 5, 6, 7, and 8, are flow diagrams showing example methods of self-cooling a headset.

Throughout the drawings, identical reference numbers designate similar, but not necessarily identical, elements.

### DETAILED DESCRIPTION

Users who wear headsets, headphones, and other head-worn audio devices for extended periods of time can experience various types of discomfort. For example, users can experience ear pain from ill-fitting ear cups, pain in the temples from ear cups pressing against eyeglasses, general headaches from ear cups that press too tightly against the user's head, and so on. Another discomfort users often complain about is having hot ears. Gamers, for example, often use headsets for extended periods of time which can lead to increases in temperature within the ear cups and around the ears where the headset cushions press against their head. As a result, many gamers and other users often complain that their ears get hot, sweaty, itchy, and generally uncomfortable.

Headsets are generally designed so that the ear cushions press hard enough against a user's head to fully enclose each ear, and to provide an audio environment favorable for producing quality sound from an incoming audio signal while blocking out unwanted noise from the ambient environment. Maintaining user comfort while providing such an audio environment can be challenging, especially during periods of extended use. In some examples, headsets can include features that help to alleviate discomforts such as the increases in temperature associated with extended use. In some examples, headsets have been designed to include a fan or fans to actively move air into and out of the enclosed areas surrounding the user's ears. In some examples, headsets have been designed to include open vents that enable a passive circulation of air into and out of the enclosed areas surrounding the user's ears. In some examples, headsets have been designed with ear cushions comprising materials capable of conducting heat away from the user's ears. Such designs can help to alleviate the increases in temperature associated with the extended use of headsets, but they can add considerable cost to the product while providing minimal relief.

Accordingly, in some examples described herein, a self-cooling headset incorporates coaxial speaker transducers (e.g., two coaxial speaker transducers; also referred to as speaker cones) to generate audible sound from a first transducer and air movement from a second transducer that provides active cooling within the enclosed areas surrounding a user's ears. In general, the phrase “self-cooling headset” is intended to indicate a headset in which a cooling function is performed in an automated fashion as a user wears and operates the headset. In some examples, a first coaxial speaker transducer, or cone, is to translate an audio signal into audible sound, while a second coaxial cone is to translate a subsonic frequency signal into air movement that produces positive and negative air pressures within the ear cup enclosure. The positive and negative air pressures are to open and close first and second valves installed, respectively, into exit and entry ports of the ear cup enclosure.

The second coaxial speaker transducer/cone refreshes air within an ear cup enclosure (i.e., the ear cup volume) by forcing air out of the enclosure through an exit port in a first or forward motion, and by drawing air into the enclosure through an entry port in a second or reverse motion. The first or forward motion of the coaxial speaker transducer causes a positive pressure within the ear enclosure. A first check valve installed at the exit port opens to let air out of the enclosure when the positive pressure caused by the coaxial speaker transducer overcomes the cracking pressure (i.e., the opening pressure) of the first valve. The second or reverse motion of the coaxial speaker transducer causes a negative pressure within the ear cup enclosure. A second check valve installed at an entry port of the ear cup enclosure opens to let ambient air into the enclosure when a negative pressure caused by the coaxial speaker transducer overcomes the cracking pressure of the second valve. The first and second check valves are installed in the ear cup in opposite orientations so that a positive pressure within the ear cup enclosure opens the first valve while sealing closed the second valve, and a negative pressure within the ear cup enclosure opens the second valve while sealing closed the first valve.

In a particular example, a self-cooling headset includes an ear cup to form an ear enclosure when placed over a user's ear. The headset includes a first valve to open and release air from the ear enclosure, and a second valve to open and admit air into the ear enclosure. A first coaxial speaker cone is to translate an audio frequency signal into audible sound, and a second coaxial speaker cone is to translate a subsonic frequency signal into air movement that produces positive and negative air pressures within the ear enclosure to open and close the first and second valves.

In another example, a non-transitory machine-readable storage medium stores instructions that when executed by a processor of a self-cooling headset, causes the headset to receive an audio signal and to filter the audio signal into an audible frequency signal and a subsonic frequency signal. The instructions further cause the headset to drive a first speaker cone of a coaxial speaker with the audible frequency signal, and to drive a second speaker cone of the coaxial speaker with the subsonic frequency signal.

In another example, a method of self-cooling a headset includes installing a first valve in an exit port of an ear cup to release air from an ear cup volume, and installing a second valve in an entry port of the ear cup to admit air into the ear cup volume. The method includes installing a coaxial speaker comprising first and second speaker cones, and a receiver to receive audio signals for driving the first speaker cone to generate audible sound. The method also includes installing a subsonic frequency generator to generate subsonic frequency signals for driving the second speaker cone to create air movement that produces positive and negative air pressures within the ear cup volume to open and close the first and second valves.

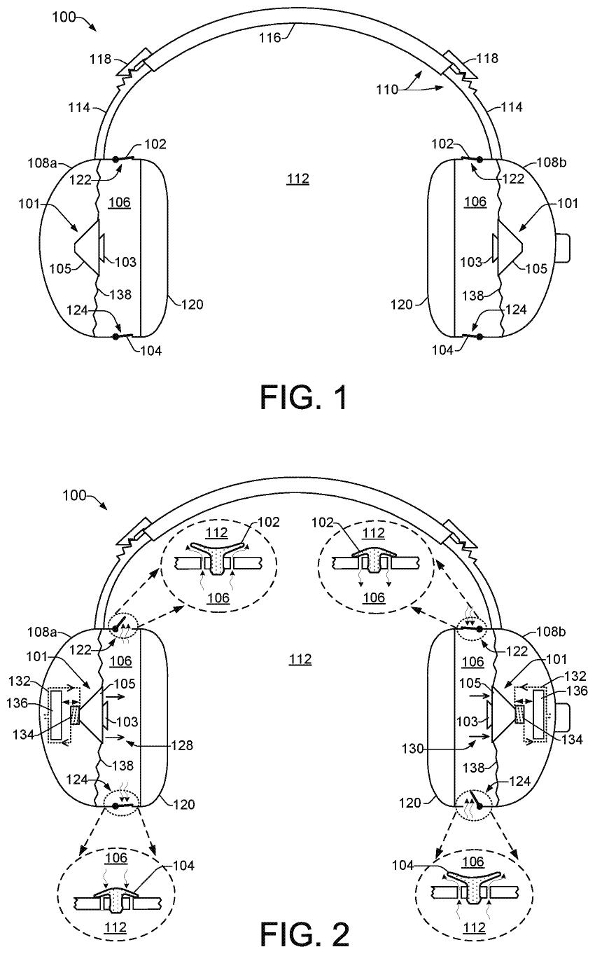

FIG. 1 shows an example of a self-cooling headset 100 in which a coaxial speaker 101 includes a first speaker cone 103 to produce audible sound, and a second speaker cone 105 to produce positive and negative air pressures that open and close check valves (102, 104) to enable active circulation of fresh air through the ear enclosure 106 of an ear cup 108. As discussed, described, illustrated, referred to, or otherwise used herein, a “check valve”, or “valve”, is intended to encompass any of a variety of valves, controllers, regulators, stopcocks, spigots, taps, or other devices that are capable of functioning as non-return-type valve devices that can enable air flow in a forward or first direction and prevent air flow in a backward or second direction. In some examples, such a valve device can include devices that employ alternate opening mechanisms such as sliding mechanisms that slide across an aperture to expose a port (e.g., ports 122, 124), an opening in the ear cup 108, different intersecting port shapes formed in the ear cup 108 that provide static openings, and so on. Thus, while the terms “check valve” or “valve” may be used throughout this description, other similarly functional devices of all types are possible and are contemplated herein for use as or within any examples.

FIG. 2 shows an example of a self-cooling headset 100 illustrating additional details to facilitate further discussion of an example construction and operation of the headset 100. Referring generally to FIGS. 1 and 2, the self-cooling headset 100 can include an ear cup 108 for each ear (i.e., illustrated in the figures as two ear cups 108a, 108b). The ear cups 108 are illustrated in partial transparency in order to better illustrate details of the ear enclosure 106 areas and additional components within the ear cups 108. The ear enclosure 106 can be generally defined as the open space or volume between a user's ear and the coaxial speaker 101. In some examples the coaxial speaker 101 can be supported within the ear cup 108 by a “surround” 138 that flexibly attaches the coaxial speaker 101 to an outer frame or “basket” of the ear cup 108. Thus, the surround 138 in combination with the coaxial speaker 101 can define the space or volume of the ear enclosure 106.

Referring still to FIGS. 1 and 2, the two ear cups 108 that are to be worn over a user's ears can be coupled to one another by a head piece 110. The head piece 110 can be adjustable to accommodate users of varying ages and head sizes. The head piece 110 can be adjustable to firmly secure each ear cup 108 against a user's head in a manner that provides an ear enclosure 106 that is isolated from the ambient environment 112 outside of the ear cup 108. Greater isolation of the ear enclosure 106 area from the ambient environment 112 can provide an improved audio experience for the user. The head piece 110 can be adjustable, for example, with extendable and retractable end pieces 114 that telescope from a center piece 116 and latch into different positions with a latching mechanism 118. Wiring (not shown) can extend through the center piece 116 and end pieces 114 to carry electric signals and power between the two ear cups 108a,108b. Cushions 120 can be attached to each ear cup 108 to help provide comfort for the user and to improve isolation of the ear enclosure 106 from the ambient environment 112. Cushions 120 can be formed, for example, from soft rubber, foam, foam-rubber, and so on.

As noted above, first and second check valves, 102 and 104, enable active circulation of fresh air through the ear enclosures 106 of ear cups 108. In some examples, check valves can be installed in ports that are formed in the ear cup 108. Such ports can provide passage ways for air to travel from the outside ambient environment 112 into the ear enclosure 106 and back into the ambient environment 112 from the enclosure 106. The first check valve 102, for example, can be installed in an exit port 122 of the ear cup 108 to enable air from within the ear enclosure 106 to exit the enclosure 106 when the first check valve 102 opens. The second check valve 104 can be installed in an entry port 124 of the ear cup 108 to enable fresh air from the ambient environment 112 to enter the ear enclosure 106 when the second check valve 104 opens. In some examples, air within the ear enclosure 106 can be warm air that has been heated during use of the headset 100 due to its close proximity to a user's ear and its confinement within the limited area of the ear enclosure 106. Active movement of warm air out of the ear enclosure 106 through an exit port 122 coupled with active movement of fresh air into the ear enclosure 106 through an entry port 124 can help to maintain user comfort.

In some examples, as shown in FIG. 2, the exit port 122 is located toward the top of the ear cup 108 and the entry port 124 is located toward the bottom of the ear cup 108 to facilitate the removal of warm air from the ear enclosure 106 as it naturally rises within the enclosure 106. In other examples, the locations of the exit port 122 and entry port 124 on the ear cup 108 can be reversed such that the exit port 122 is located toward the bottom and the entry port 124 is located toward the top. In other examples, the exit port 122 and entry port 124 can be located at various different positions around the ear cup 108.

The first and second check valves, 102 and 104, can open and close to allow air to pass into and out of the ear enclosure 106 based on the valve orientations and based on a differential pressure between the volume of air within the ear enclosure 106 and the air in the ambient environment 112. As shown in FIG. 2, for example, the first check valve 102 comprises an outward oriented (i.e., outward opening) check valve that can open in a single outward direction to enable air to escape from the ear enclosure 106 through the exit port 122 and into the ambient environment 112. The first check valve 102 has an associated cracking pressure (i.e., opening pressure) that indicates a minimum opening pressure that will cause the check valve to open in the single outward direction. This is indicated in the left ear cup 108a of FIG. 2 by small wavy arrows pointing in a direction from inside the ear enclosure 106 to the ambient environment 112 outside of the ear cup 108a. Thus, when pressure within the ear enclosure 106 overcomes the cracking pressure of the first check valve 102, the first check valve 102 opens outward and allows air to escape from within the ear enclosure 106 and pass through the exit port 122 into the ambient environment 112. When the pressure within the ear enclosure 106 falls below the cracking pressure of the first check valve 102, the valve 102 closes. As noted above, a “check valve” as used throughout this description is intended to encompass other similarly functional devices of all types that are capable of functioning as non-return-type valve devices. Thus, a “cracking pressure” as used herein is intended to refer to and generally apply to any such devices as an “opening pressure” that is sufficient to begin to open any such device.

Similarly, but in an opposite way, the second check valve 104 comprises an inward oriented (i.e., inward opening) check valve that can open in a single inward direction to enable air to enter the ear enclosure 106 from the ambient environment 112 through the entry port 124. The second check valve 104 has an associated cracking pressure that indicates a minimum opening pressure that will cause the check valve to open in the single inward direction. This is shown in the right ear cup 108b of FIG. 2 by small wavy arrows pointing in a direction from the ambient environment 112 outside of the ear cup 108b and into the ear enclosure 106. Thus, when a partial vacuum or negative pressure within the ear enclosure 106 (i.e., negative pressure relative to the outside ambient environment 112) overcomes the cracking pressure of the second check valve 104, the second check valve 104 opens inward and allows fresh air from the ambient environment 112 to pass through the entry port 124 and into the ear enclosure 106. When the partial vacuum or negative pressure within the ear enclosure 106 falls below the cracking pressure of the second check valve 104, the valve 104 closes.

The first and second check valves, 102 and 104, operate in an opposing manner with respect to one another. More specifically, while a positive pressure within the ear enclosure 106 acts to open the first check valve 102, as discussed above, it simultaneously acts to force the second check valve 104 closed. Similarly, while a partial vacuum or negative pressure within the ear enclosure 106 acts to open the second check valve 104, it simultaneously acts to force the first check valve 102 closed. In some examples, the cracking pressure of the first and second check valves can be the same pressure, while in other examples, the first and second check valves may have cracking pressures that are different from one another.

In different examples, the check valves 102 and 104 can be implemented using different types of check valves. Different types of check valves that may be appropriate include diaphragm check valves, umbrella check valves, ball check valves, swing check valves, lift-check valves, in-line check valves, and combinations thereof. Thus, while check valves 102 and 104 are illustrated herein as being umbrella check valves, other types of check valves that can open to permit air to flow in a first direction and close to prevent air from flowing in an opposite direction are possible and are contemplated herein.

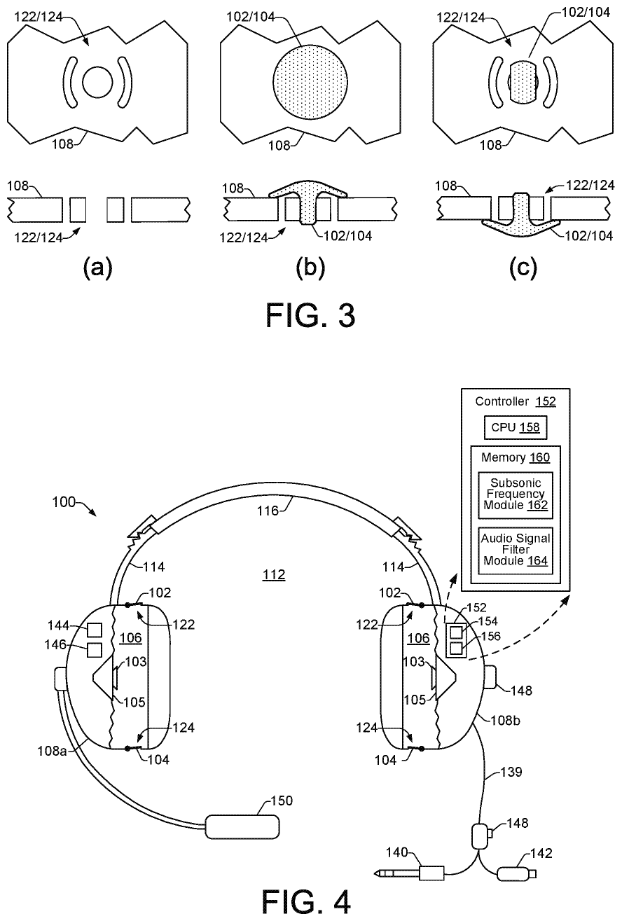

FIG. 3 shows a more detailed view of how an example umbrella check valve may be implemented within an entry and exit port 122/124 of an ear cup 108. FIG. 3a illustrates a top down view and a side view of an example entry or exit port 122/124 formed in the surface of an ear cup 108 that is suitable to accommodate an umbrella check valve. The example port includes a circular hole into which the valve of an umbrella check valve can be seated, and two passages through the ear cup 108 surface that enable air to pass between the ear enclosure 106 and the ambient environment 112. FIG. 3b illustrates a top down view and a side view of an example umbrella check valve 102/104 whose valve stem is seated in the port with the check valve closed over the two air passages of the port. FIG. 3c illustrates a bottom up view and a side view of an example umbrella check valve 102/104 whose valve stem is seated in the port with the check valve closed over the two air passages of the port.

As noted above with reference to FIG. 1, examples of a self-cooling headset 100 include a coaxial speaker 101 that produces audible sound in addition to producing positive and negative air pressures within the ear enclosure that can open and close the check valves 102 and 104. More specifically, a coaxial speaker 101 in each ear cup 108 includes a first coaxial speaker cone 103 to produce audible sound, and a second coaxial speaker cone 105 to produce the positive and negative air pressures to open and close the check valves 102 and 104, providing an active circulation of fresh air through the ear enclosure 106 of an ear cup 108. While first and second speaker cones 103, 105, are illustrated in the figures and discussed throughout this description as being coaxial with one another, other arrangements for first and second (or more) speaker cones may be useful for providing the same or similar functions and are therefore contemplated herein. For example, it is possible that first and second speaker phones may be situated within the ear cup 108 at different or uncommon locations with respect to one another.

In general, some examples of coaxial speakers can comprise two-way speakers in which a “tweeter” or high-range cone is mounted coaxially in front of a “woofer” or low-range cone. In other examples, coaxial speakers can comprise three-way speakers in which a “tweeter” cone and a “mid-range” cone are both mounted coaxially in front of a “woofer” cone. Thus, while the example coaxial speaker 101 illustrated and discussed herein includes two speaker cones; i.e., a first speaker cone 103 analogous to a tweeter for producing audible sound, and a second speaker cone 105 analogous to a woofer for creating positive and negative air pressures; in other examples the coaxial speaker 101 may also include a mid-range cone to produce portions of the audible sound.

Referring again generally to FIG. 2, the operation of the speaker cones 103 and 105, of coaxial speaker 101 can be shown. The smaller, first speaker cone 103 can operate to produce audible sound from an incoming audio frequency signal, and the larger, second speaker cone 105 can operate to produce air movement from a subsonic frequency signal. An audio frequency signal includes signals within the audible frequency range in which humans can hear, sometimes referred to as the audio spectrum. The audio spectrum is considered to cover audible frequencies between about 20 Hz to about 20,000 Hz. Thus, rendering audio frequency signals (e.g., through speaker cone 103) can produce audible sound waves or vibrations within the ear enclosure 106 of an ear cup 108. A subsonic frequency signal includes signals that are below the audible frequency range. Thus, subsonic frequency signals can be signals below 20 Hz, and in some examples subsonic frequency signals are considered to cover frequencies between about 5 Hz to about 15 Hz. Rendering subsonic frequency signals (e.g., through a speaker cone 105) can produce air movement as subsonic or infrasonic waves or vibrations within the ear enclosure 106 of an ear cup 108 that are below audible sound. Such subsonic or infrasonic waves, sometimes referred to as low-frequency “sound” or “infrasound”, can produce positive and negative air pressures within the ear enclosure 106 that can open and close check valves 102 and 104 to actively circulate fresh air through the enclosure 106.

During operation, the first and second coaxial speaker cones 103 and 105 can translate in a forward direction 128 as shown in ear cup 108a, and in a reverse direction 130 as shown in ear cup 108b. The forward and reverse translations of the speaker cones 103 and 105 are independent from one another. That is, the first speaker cone 103 can be translating in the forward direction 128 while the second speaker cone 105 is translating in the reverse direction 130, and vice versa. Components of a speaker transducer that generate the forward and reverse motions of the speaker cones 103, 105, include a voice coil 132 wrapped around a coil-forming cylinder 134, and a permanent/stationary magnet 136. To simplify the discussion and the illustration in FIG. 2, one voice coil 132, coil-forming cylinder 134, and magnet 136, have been shown for each coaxial speaker 101. However, for each coaxial speaker 101, there is a separate voice coil, coil-forming cylinder, and magnet, for each of the speaker cones in the coaxial speaker 101. Thus, while a single voice coil 132, coil-forming cylinder 134, and magnet 136 are shown, it should be understood that the first and second speaker cones 103, 105 are each driven by their own separate voice coil 132, coil-forming cylinder 134, and magnet 136. During operation, incoming electrical signals (e.g., audio signals, subsonic signals) traveling through the coil 132, turn the coil 132 into an electromagnet that attracts and repels the permanent/stationary magnet 136. The attraction and repulsion of the magnet 136 by the coil 132 causes movement of the coil 132 and its respective speaker cone 103 or 105, in a forward and reverse direction according to the incoming electrical signals.

As the first coaxial speaker cone 103 is driven back and forth in forward 128 and reverse 130 directions according to an audio frequency signal, it produces audible sound. As the second coaxial speaker cone 105 is driven back and forth in forward 128 and reverse 130 directions according to a subsonic frequency signal, it can generate pressure differentials between the ear enclosure 106 and the outside ambient environment 112 that open and close the check valves 102 and 104. More specifically, when the second speaker cone 105 translates or moves in a forward direction 128 as shown in ear cup 108a, it can generate a positive pressure within the ear enclosure 106 that overcomes the cracking pressure of the first check valve 102, which causes the valve 102 to open and release air from the ear enclosure 106 into the ambient environment 112. Similarly, but oppositely, when the second speaker cone 105 translates or moves in a reverse direction 130 as shown in ear cup 108b, it can create a partial vacuum or negative pressure within the ear enclosure 106 (i.e., a negative pressure differential between the ear enclosure 106 and ambient environment 112) that can overcome the cracking pressure of the second check valve 104, which causes the valve 104 to open and admit fresh air from the ambient environment 112 into the ear enclosure 106.

FIG. 4 shows an example of a self-cooling headset 100 illustrating alternate example operating modes and additional details of an example construction and operation of the headset 100. As noted above, the first coaxial speaker cone 103 can be driven by an audio frequency signal to produce audible sound. Accordingly, a headset 100 can include an audio frequency signal receiver such as an audio cable 139 to receive power and audio signals from an audio source, such as a stereo system, a gaming system, or a computer system (not shown). The audio cable 139 can include an audio jack 140 and/or USB plug 142 to plug into the audio source. Thus, an audio cable 139 with an audio jack 140 and/or USB plug 142 can act as a wired audio signal receiver and power receiver. In some examples, a self-cooling headset 100 can comprise a wireless headset powered by batteries or a battery pack 144. Thus, a headset can include an audio frequency signal receiver implemented as an onboard wireless receiver 146. Some examples of a wireless receiver 146 can include a Bluetooth receiver, a zigbee receiver, a z-wave receiver, a near-field-communication (nfc) receiver, a wi-fi receiver, and an RF receiver. In some examples, a control dial 148 can be positioned on the audio cable 139 or on an ear cup 108. A control dial 148 can be used, for example, to adjust audio volume and select between different audio signals coming through the audio cable 139 or through a wireless receiver 146. In some examples, a self-cooling headset 100 can include a microphone 150 coupled to an ear cup 108. Computer gaming headsets often include a microphone to enable interaction between players.

In some examples, a self-cooling headset 100 includes a controller 152 that can perform various functions such as providing an on-board subsonic frequency generator 154 and an audio signal filter 156. The subsonic frequency generator 154 can generate a subsonic frequency signal used for driving the second speaker cone 105 to produce positive and negative pressures within the ear enclosure 106 that can open and close the first and second valves 102 and 104. In some examples, when an incoming audio signal has a broad frequency range that extends below the audible frequency range of approximately 20 Hz, an audio signal filter 156 can filter the incoming audio signal into an audible frequency signal comprising audible frequencies between about 20 Hz to about 20,000 Hz, and a subsonic frequency signal comprising subsonic frequencies that are below 20 Hz. The audio signal filter 156 can direct the audible frequency signal to the first speaker cone 103 to be rendered as audible sound waves, and the subsonic frequency signal to the second speaker cone 105 to be rendered as subsonic waves.

In some examples, the subsonic frequency generator 154 comprises an independent generator that can drive the second speaker cone 105 independent of an audio signal and/or a subsonic frequency signal that may be directed to the second speaker cone 105 from the audio signal filter 156. Thus, in some examples the second speaker cone 105 can be driven simultaneously by subsonic frequency signals from both the subsonic frequency generator 154 and the audio signal filter 156. However, the subsonic frequency generator 154 can also drive the second speaker cone 105 even when there is no audio signal being received by the headset 100. In other examples, the subsonic frequency generator 154 may comprise a dependent generator that can drive the second speaker cone 105 depending on whether or not a subsonic frequency signal is being directed to the second speaker cone 105 from the audio signal filter 156. For example, when a subsonic frequency signal is being directed to the second speaker cone 105 from the audio signal filter 156, the subsonic frequency generator 154 may pause or cease functioning.

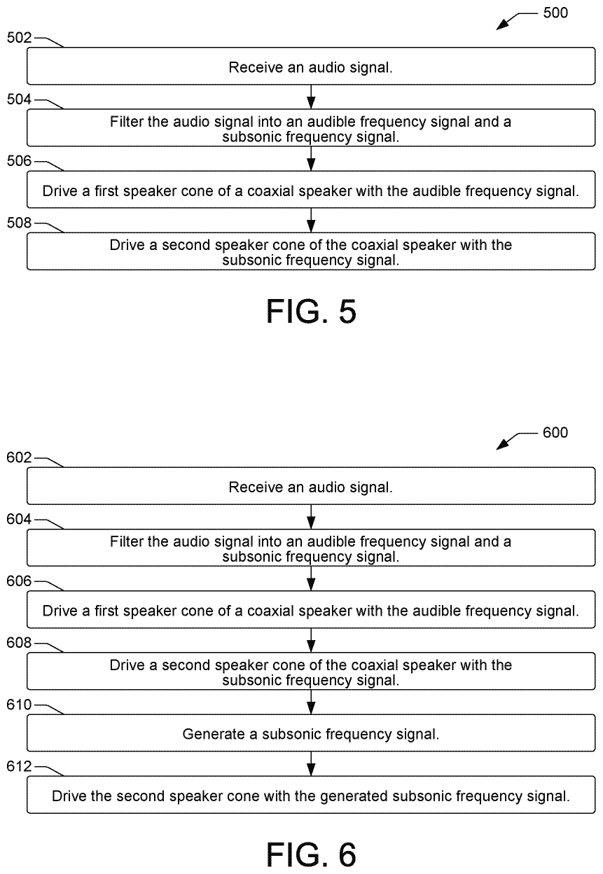

As shown in FIG. 4, an example controller 152 can include a processor (CPU) 158 and a memory 160. The controller 152 may additionally or alternately include other electronics (not shown), such as discrete electronic components and an ASIC (application specific integrated circuit). Memory 160 can include both volatile (i.e., RAM) and nonvolatile memory components (e.g., ROM, flash memory, etc.). The components of memory 160 comprise non-transitory, machine-readable (e.g., computer/processor-readable) media that can provide for the storage of machine-readable coded program instructions, data structures, program instruction modules, and other data and/or instructions executable by a processor 158. Thus, the subsonic frequency generator 154 and the audio signal filter 156 each generally comprise a processor 158 programmed with instructions that when executed, cause the headset 100 to perform, respectively, subsonic frequency generation and audio signal filtering. For example, the subsonic frequency generator 154 can comprise the processor 158 programmed to execute instructions from a subsonic frequency module 162 stored in memory 160, while the audio signal filter 156 can comprise the processor 158 programmed to execute instructions from an audio signal filter module 164 stored in memory 160. Thus, modules 162 and 164 include programming instructions executable by processor 158 to cause the self-cooling headset 100 to perform various functions related to subsonic frequency generation and audio signal filtration, such as the operations of methods 500, 600, and 700, described below with respect to FIGS. 5, 6, and 7.

FIGS. 5, 6, 7, and 8, are flow diagrams showing example methods 500, 600, 700, and 800, of self-cooling a headset. Methods 600 and 700 are extensions of method 500 that incorporate additional details. The methods 500, 600, 700, and 800 are associated with examples discussed above with regard to FIGS. 1-4, and details of the operations shown in methods 500, 600, 700, and 800 can be found in the related discussion of such examples. The operations of methods 500, 600, and 700 may be embodied as programming instructions stored on a non-transitory, machine-readable (e.g., computer/processor-readable) medium, such as memory 160 shown in FIG. 4. In some examples, implementing the operations of methods 500, 600, and 700 can be achieved by a processor, such as a processor 158 of FIG. 4, reading and executing the programming instructions stored in a memory 160. In some examples, implementing the operations of methods 500, 600, and 700 can be achieved using an ASIC and/or other hardware components alone or in combination with programming instructions executable by a processor 158.

In some examples, the methods 500, 600, 700, and 800 may include more than one implementation, and different implementations of methods 500, 600, 700, and 800 may not employ every operation presented in the flow diagrams of FIGS. 5-8. Therefore, while the operations of methods 500, 600, 700, and 800 are presented in a particular order within their respective flow diagrams, the order of their presentation is not intended to be a limitation as to the order in which the operations may actually be implemented, or as to whether all of the operations may be implemented. For example, one implementation of method 600 might be achieved through the performance of a number of initial operations, without performing one or more subsequent operations, while another implementation of method 600 might be achieved through the performance of all of the operations.

Referring now to the flow diagram of FIG. 5, an example method 500 of self-cooling a headset begins at block 502 with receiving an audio signal. An audio signal can be received, for example, through a wired audio cable or through a wireless receiver. As shown at block 504, the method 500 includes filtering the audio signal into an audible frequency signal and a subsonic frequency signal. The method 500 can also include driving a first speaker cone of a coaxial speaker with the audible frequency signal, and driving a second speaker cone of the coaxial speaker with the subsonic frequency signal as shown, respectively, at blocks 506 and 508.

As noted above, methods 600 and 700 are extensions of example method 500 that incorporate additional details. Accordingly, the first operations of methods 600 and 700 can be the same or similar to the first operations of method 500. Thus, as shown at blocks 602-608, the example method 600 can include receiving an audio signal, filtering the audio signal into an audible frequency signal and a subsonic frequency signal, driving a first speaker cone of a coaxial speaker with the audible frequency signal, and driving a second speaker cone of the coaxial speaker with the subsonic frequency signal. The method 600 can additionally include generating a subsonic frequency signal, and driving the second speaker cone with the generated subsonic frequency signal, as shown at blocks 610 and 612. In different examples, a subsonic frequency signal from the audio signal filtering and the generated subsonic frequency signal can drive the second speaker cone simultaneously or independently.

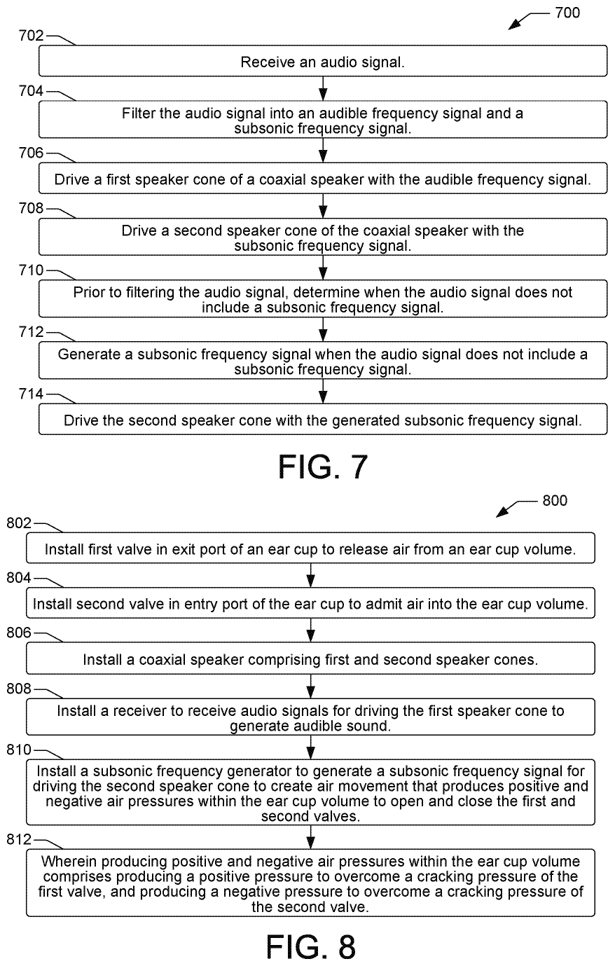

Referring now to FIG. 7, another example method 700 of self-cooling a headset can include receiving an audio signal, filtering the audio signal into an audible frequency signal and a subsonic frequency signal, driving a first speaker cone of a coaxial speaker with the audible frequency signal, and driving a second speaker cone of the coaxial speaker with the subsonic frequency signal, as shown at blocks 702-708. The method 700 can additionally include, prior to filtering the audio signal, determining when the audio signal does not include a subsonic frequency signal, and generating a subsonic frequency signal when the audio signal does not include a subsonic frequency signal, as shown at blocks 710 and 712. As shown at block 714, the method can then include driving the second speaker cone with the generated subsonic frequency signal.

Referring now to FIG. 8, another example method 800 of self-cooling a headset can begin with installing a first valve in an exit port of an ear cup to release air from an ear cup volume, and installing a second valve in an entry port of the ear cup to admit air into the ear cup volume, as shown respectively at blocks 802 and 804. The method 800 can also include installing a coaxial speaker comprising first and second speaker cones, and installing a receiver to receive audio signals for driving the first speaker cone to generate audible sound, as shown respectively at blocks 806 and 808. In some examples, as shown at block 810, the method can include installing a subsonic frequency generator to generate a subsonic frequency signal for driving the second speaker cone to create air movement that produces positive and negative air pressures within the ear cup volume to open and close the first and second valves. As shown at block 812, producing positive and negative air pressures within the ear cup volume can comprise producing a positive pressure to overcome a cracking pressure of the first valve, and producing a negative pressure to overcome a cracking pressure of the second valve.

What is claimed is:

1. A self-cooling headset comprising:
an ear cup to form an ear enclosure when placed over a user's ear;
a first valve to open and release air from the ear enclosure;
a second valve to open and admit air into the ear enclosure;
a first speaker cone to translate an audio frequency signal into audible sound; and,
a second speaker cone to translate a subsonic frequency signal into air movement that produces positive and negative air pressures within the ear enclosure to open and close the first and second valves.

2. A self-cooling headset as in claim 1, wherein the first and second speaker cones comprise coaxial speaker cones.

3. A self-cooling headset as in claim 1, further comprising a subsonic frequency generator to generate the subsonic frequency signal.

4. A self-cooling headset as in claim 3, wherein the subsonic frequency generator comprises:
a memory to store a subsonic frequency pattern and subsonic frequency generation instructions;
a processor programmed with the subsonic frequency generation instructions to control the second speaker cone to translate the subsonic frequency signal into air movement that produces the positive and negative air pressures.

5. A self-cooling headset as in claim 1, further comprising an audio signal receiver selected from the group consisting of an audio cable and a wireless receiver.

6. A self-cooling headset as in claim 1, wherein the first speaker cone comprises an audible spectrum speaker cone to translate audio frequency signals into audible sound and the second cone comprises a low frequency cone to translate subsonic frequency signals into inaudible air movement.

7. A self-cooling headset as in claim 1, wherein the first speaker cone comprises an audio speaker cone to translate audio frequency signals within a frequency range of about 20 Hz to about 20,000 Hz into audible sound.

8. A self-cooling headset as in claim 1, wherein the second speaker cone comprises a subsonic speaker cone to translate subsonic frequency signals within a frequency range of about 5 Hz to about 15 Hz into air movement that produces positive and negative air pressures within the ear enclosure.

9. A self-cooling headset as in claim 3, wherein the subsonic frequency generator comprises an independent generator to drive the second speaker cone independent of the audio frequency signal.

10. A self-cooling headset as in claim 1, wherein:
the first and second valves comprise, respectively, first and second cracking pressures;
the first cracking pressure can be overcome to open the first valve by a positive air pressure produced from the second speaker cone; and,
the second cracking pressure can be overcome to open the second valve by a negative air pressure produced from the second speaker cone.

11. A non-transitory machine-readable storage medium storing instructions that when executed by a processor of a self-cooling headset, cause the headset to:
receive an audio signal;
filter the audio signal into an audible frequency signal and a subsonic frequency signal;
drive a first speaker cone of a coaxial speaker with the audible frequency signal; and,
drive a second speaker cone of the coaxial speaker with the subsonic frequency signal.

12. A medium as in claim 11, wherein the instructions further cause the headset to:
generate a subsonic frequency signal; and,
drive the second speaker cone with the generated subsonic frequency signal.

13. A medium as in claim 11, wherein the instructions further cause the headset to:
prior to filtering the audio signal, determine when the audio signal does not include a subsonic frequency signal;
generate a subsonic frequency signal when the audio signal does not include a subsonic frequency signal; and,
drive the second speaker cone with the generated subsonic frequency signal.

14. A method of self-cooling a headset comprising:
installing a first valve in an exit port of an ear cup to release air from an ear cup volume;
installing a second valve in an entry port of the ear cup to admit air into the ear cup volume;
installing a coaxial speaker comprising first and second speaker cones;
installing a receiver to receive audio signals for driving the first speaker cone to generate audible sound; and,
installing a subsonic frequency generator to generate subsonic frequency signals for driving the second speaker cone to create air movement that produces positive and negative air pressures within the ear cup volume to open and close the first and second valves.

15. A method as in claim 14, wherein producing positive and negative air pressures within the ear cup volume comprises producing a positive pressure to overcome a cracking pressure of the first valve, and producing a negative pressure to overcome a cracking pressure of the second valve.
